(19) United States
(12) Patent Application Publication
(10) Pub. No.: US 2005/0200705 A1
(43) Pub. Date: Sep. 15, 2005

(54) System and method for thwarting the recording of visual images of individuals using a portable camera controller

(76) Inventor: Jerry Nieto, Huntington Beach, CA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/800,379

(22) Filed: Mar. 12, 2004

(51) Int. Cl. H04N 5/225

(52) U.S. Cl. 348/207.99; 398/106

(57) ABSTRACT

A portable camera controller (PCC) broadcasts a library of commands to a plurality of remotely controllable imaging devices (RCIDs) thereby thwarting the recording of the visual image of the user. A PCC comprises at least one infrared (IR) emitter and a library of IR commands known to control the functions of RCIDs. The library of IR commands comprises a set of commands for each RCID that includes at least one command that controls the stop, pause, and rewind functions of that device. Upon command of a user, the PCC broadcasts the library of IR commands in omnidirectionally. An RCID within range of the PCC responds to the commands that are specific to its control functions thereby precluding the RCID from recording a visual image within range of the PCC.

### BACKGROUND

The present invention relates generally to thwarting the recording of visual images of individuals and more particularly to a portable camera controller that prevents or interrupts the normal operation of a video or still camera that is used for that purpose.

The world is fascinated with public figures. The media pursues stories involving princesses, movie stars, sport stars, pop singers, people accused of crimes, victims of crimes and the like (collectively, “media targets”). Driving this media juggernaut is an insatiable public appetite for news and, more invasively, photographs of individuals who for one reason or another have become media targets.

Visual images (moving or still) are particularly invasive because they may be taken surreptitiously and at moments when a media target has a particularly high expectation of privacy. Additionally, visual images may be circulated electronically over the Internet. Once in the public domain, visual images are virtually impossible to recover. Further, visual images may be manipulated to distort the image of the media target or to distort or fabricate the context in which the visual image appears. Often, visual images of media targets include visual images of bystanders who may, as a result of the circulation of the visual image, become media target.

Following the death of Princess Dianna, laws were proposed, and in some states passed, to protect the privacy of media targets. While laws provide legal recourse for violation of privacy rights, legal recourse cannot undo the event itself. The process of fighting an invasion of privacy can easily compound the injury to the media target and attract even more attention from the media.

On one level, the public decries as an invasion of a “right” to privacy represented byjunk mail, spam, and phone solicitation. On another level the public wants to learn all that it can about media targets, often without regard to the privacy of the media targets or those in proximity to the media targets. This places the media target at the mercy of the reporters and photographers (sometimes, though not kindly, referred to as the “paparazzi”).

What is needed are means that provide an individual protection from undesired capturing of visual images. Such means would be portable, easy to use, and effective to thwart the capturing of visual images from the individual without harming the imaging device or the person using it.

### SUMMARY

An embodiment of the present invention is a portable camera controller (PCC) that broadcasts a library of commands to a plurality of remotely controllable imaging devices (RCIDs) thereby thwarting the recording of the visual image of the user. By way of illustration and not as a limitation, RCIDs include remotely controllable video recorders (sometime referred to as Camcorders) without regard to the type of media used to store the recorded visual image and still cameras that are remotely controllable. In one embodiment of the present invention, the PCC comprises at least one infrared (IR) emitter and a library of IR commands known to control the functions of RCIDs. In an embodiment of the present invention, the library of IR commands comprises a set of commands for each RCID that includes at least one command that controls the stop, pause, and rewind functions of that device. Upon command of a user, the PCC broadcasts the library of IR commands in an omnidirectional fashion. An RCID within range of the PCC responds to the commands that are specific to its control functions thereby precluding the RCID from recording a visual image visual image within range of the PCC.

It is therefore an aspect of the present invention to use a PCC to thwart the capture of a visual image of a media target by an RCID.

It is another aspect of the present invention to store in a PCC a library of IR commands that control the basic functions of a plurality of RCIDs.

It is another aspect of the present invention to transmit a library of IR commands from a PCC to thwart the recording of a visual image of a media target from all controllable RCIDs within range of the PCC regardless of the brand or manufacturer of the RCID.

It is yet another aspect of the present invention to incorporate an interface into a PCC to allow new IR commands to be added to an IR command library.

It is still another aspect of the present invention to transmit IR commands from a PCC using one or more of IR emitters that transmit in the invisible IR spectrum.

These and other aspects of the present invention will become apparent from a review of the general and detailed descriptions that follow.

In an embodiment of the present invention, a portable camera controller comprises a flash memory in which an infrared (IR) command library is stored. Optionally, at least one IR command associated with each of a plurality of RCIDs is selected from the group consisting of a stop command, a pause command, and a rewind command. The IR command library comprises at least one IR command associated with each of a plurality of remotely controllable imaging devices (RCIDs). A processor for receiving the IR command library is connected to the flash memory. The processor directs the IR command library to an IR encoder. One or more IR emitters are connected to the IR encoder for transmitting the IR command library. Receipt of the at least one IR command associated with one of the plurality of RCIDs by that RCID interferes with the recording of a visual image by that RCID. In another embodiment of the present invention, the portable camera controller further comprises a timer connected to the processor. The processor is adapted to respond to a timing pulse from the timer by retrieving and transmitting the IR command library. The timer is adapted to send the timing pulse periodically to the processor.

In another embodiment of the present invention, a portable camera controller comprises a flash memory in which an infrared (IR) command library is stored. Optionally, at least one IR command associated with each of a plurality of RCIDs is selected from the group consisting of a stop command, a pause command, and a rewind command. The IR command library comprises at least one IR command associated with each of a plurality of remotely controllable imaging devices (RCIDs). A processor for receiving the IR command library is connected to the flash memory. The processor directs the IR command library to an IR encoder. IR emitters are connected to the IR encoder for transmitting the IR command library. The IR emitters are arranged so as transmit the IR command library omnidirectionally. Receipt of the at least one IR command associated with one of the plurality of RCIDs by that RCID interferes with the recording of a visual image by that RCID. In another embodiment of the present invention, the portable camera controller further comprises a timer connected to the processor. The processor is adapted to respond to a timing pulse from the timer by retrieving and transmitting the IR command library. The timer is adapted to send the timing pulse periodically to the processor.

Yet another embodiment of the present invention provides a method for thwarting the recording of a visual image using a portable camera controller. A timing pulse is generated. Optionally, the timing pulse is generated periodically. In response to the timing pulse an IR command library is received. The IR command library comprises at least one IR command associated with each of a plurality of remotely controllable imaging devices (RCIDs). Optionally, at least one IR command associated with each of a plurality of RCIDs is selected from the group consisting of a stop command, a pause command, and a rewind command. The IR command library is transmitter from one or more IR emitters, wherein receipt of the at least one IR command associated with one of the plurality of RCIDs by that RCID interferes with the recording of a visual image by that RCID.

### DESCRIPTION OF THE DRAWINGS

FIG. 1 illustrates a block diagram of the logical components of a portable camera controller according to embodiments of the present invention.

FIG. 2 illustrates a flow of a process of thwarting the recording of a visual image of a media target using a PCC according to embodiments of the present invention.

### DETAILED DESCRIPTION

An embodiment of the present invention is a portable camera controller (PCC) that broadcasts a library of commands to a plurality of remotely controllable imaging devices (RCIDs) thereby thwarting the recording of the visual image of the user. By way of illustration and not as a limitation, RCIDs include remotely controllable video recorders (sometime referred to as Camcorders) without regard to the type of media used to store the recorded visual image and still cameras that are remotely controllable. In one embodiment of the present invention, the PCC comprises at least one infrared (IR) emitter and a library of IR commands known to control the functions of RCIDs. In an embodiment of the present invention, the library of IR commands comprises a set of commands for each RCID that includes at least one command that controls the stop, pause, and rewind functions of that device. Upon command of a user, the PCC broadcasts the library of IR commands omnidirectionally. An RCID within range of the PCC responds to the commands that are specific to its control functions thereby precluding the RCID from recording a visual image within range of the PCC.

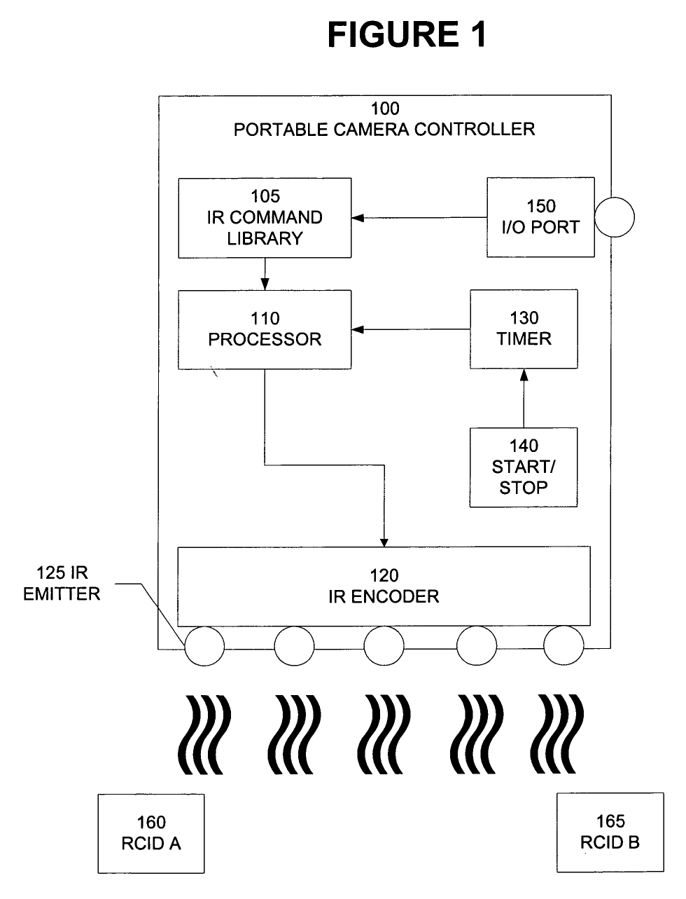

FIG. 1 illustrates a block diagram of the logical components of a portable camera controller according to embodiments of the present invention. Referring to FIG. 1, PCC 100 comprises an IR command library 105 accessible to a processor 110. A start/stop switch 140 initiates a timer 130 that causes processor 110 to retrieve the contents of the IR command library 105 and send IR commands to IR encoder 120 for transmission. In an embodiment of the present invention, the IR emitters 125 are arranged to broadcast the IR commands omnidirectionally.

IR command library 105 comprises IR commands for a plurality of commercially available RCIDs. In an embodiment of the present invention, the IR commands include stop, pause, and rewind. However, the present invention is not so limited. As will be apparent to those skilled in the art, other IR commands may be included in the IR command library 105 without departing from the scope of the present invention. By way of illustration and not as a limitation, an IR command for microphone mute could be incorporated into the IR command library 105 to thwart sound recordings as will as visual image recordings.

In another embodiment of the present invention, the IR commands within the IR command library 105 are organized by the brand name under which an RCID is sold. In this embodiment, the IR commands for each RCID of a particular product brand are transmitted as a block. However, the present invention is not so limited. As will be apparent to those skilled in the art, the order in which the IR commands are transmitted by the PCC is not significant. For example, the IR commands may be ordered by brand name from highest sales volume to lowest sales volume.

A timer 130 cycles the processor 110 to repeat the transmission of the IR command library over a pre-determined period of time. In an exemplary embodiment of the present invention, the clock cycle is thirty seconds.

IR encoder 120 is connected to at least one IR emitter 125. In an exemplary embodiment of the present invention, IR encoder 120 is connected to a plurality of commercially available IR emitters 125. In an exemplary embodiment of the present invention, the IR emitters 125 transmit in the “invisible” IR spectrum so as not to be detectable by currently available night vision equipment. Additionally, the IR emitters are selected to have sufficient power to control an RCID within a desirable range. In the exemplary embodiment, the range of control was about sixty feet in daylight. While as illustrated in FIG. 1 the IR encoder 120 is associated with 5 IR emitters 125, the invention is not so limited by the illustration. More or fewer IR emitters may be used. As will apparent to those skilled in the art, adding IR emitters permits the PCC to cover a circular area with increasing power and effectiveness, but increases the power requirements of the PCC. In an exemplary embodiment of the present invention, five IR emitters 125 were able to provide coverage over a circular area with a range of about sixty feet using four AAA batteries for power (not illustrated).

Also illustrated in FIG. 1 is I/O port 150. I/O port 150 provides means for writing to the IR command library 105 to update, correct, or add IR commands for RCIDs not previously included in the IR command library. In an embodiment of the present invention, I/O port 150 is a USB port, however this is not a limitation. Any means for transferring IR commands into the IR command library may be used to accomplish the assigned task of the I/O port 150.

IR commands broadcast by the IR emitters 125 are received by sensors (not illustrated) in RCID A 160 and RCID B 165 according to their designs. When an RCID (160 and 165) receives a command that it is programmed to recognize, the IR command is implemented by the RCID (160 and 165). If the RCID (160 and 165) is in the RECORD mode, the implementation of the IR command causes the RCID (160 and 165) to leave the RECORD mode thereby disrupting the recording of a visual image in the vicinity of the PCC. The PCC repeats the transmission of the IR commands in the IR command library for as long as the PCC remains active. Under these conditions, the user of an affected RCID will not be able to return that device to RECORD mode for any useful length of time, if at all, until the PCC is deactivated—presumably when the media target is no longer within range of any RCIDs.

In an exemplary embodiment, a PCC 100 was made by modifying a commercially available programmable remote control manufactured by Intrigue Technologies Inc. and sold under the brand name “Harmony.” The model used was the Harmony SST 748 comprising a 1-megabyte flash memory and a USB port for connection to a personal computer. The flash memory (used to store the IR command library 105) was upgraded to provide additional memory and a timer circuit (130) was added. The single IR emitter was replaced with five invisible IR emitters (125) and arranged externally to broadcast in a circular pattern. The PCC was found to be effective at a range of approximately sixty feet from the PCC.

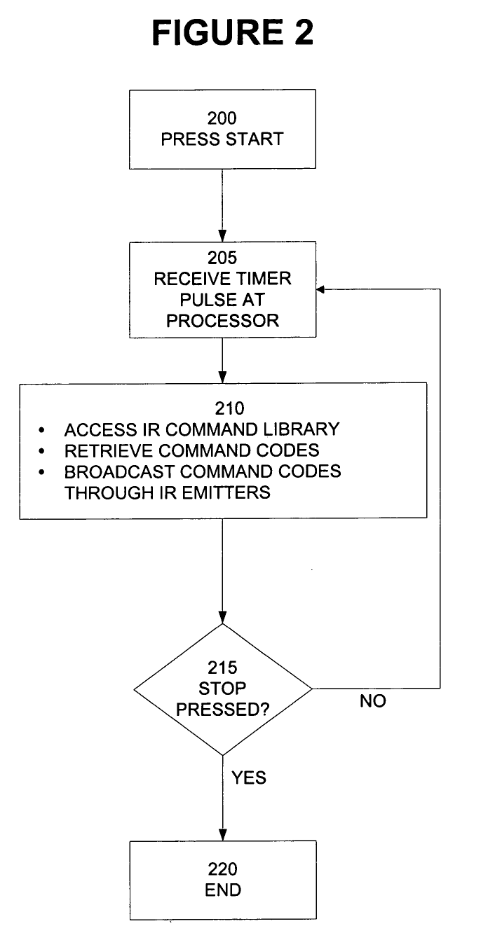

FIG. 2 illustrates a flow of a process of thwarting the recording of a visual image of a media target using a PCC according to embodiments of the present invention. Referring to FIG. 2, a “start” command is issued on a PCC 200. A processor 205 receives a timing pulse. In response to the timing pulse, the processor accesses an IR command library, retrieves the command codes stored there, transmits the command codes via one or more IR emitters sequentially until the all codes have been sent 210. A determination is made if a “stop” command has been given 215. If a stop command is given, the transmission of the command codes ceases 220. If a stop command has not been given, the process returns to receiving a timing pulse 205 and the process continues. As will be apparent to those skilled in the art, the period between timing pulses should be at least as long as the time required to send all of the IR commands in the IR command library.

IR commands broadcast by the IR emitters are received by sensors in RCIDs according to their designs. When an RCID receives a command that it is programmed to recognize, the IR command is implemented by the RCID. If the RCID is in the RECORD mode, the implementation of the IR command causes the RCID to leave the RECORD mode thereby disrupting the recording of a visual image in the vicinity of the PCC. The PCC repeats the transmission of the IR commands in the IR command library for as long as the PCC remains active. Under these conditions, the user of an affected RCID will not be able to return that device to RECORD mode for any useful length of time, if at all, until the PCC is deactivated—presumably the media target is no longer within range of any RCIDs.

A portable camera control has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

1. A portable camera controller comprising:
a flash memory comprising an infrared (IR) command library, wherein the IR command library comprises at least one IR command associated with a remotely controllable imaging devices (RCIDs);
a processor for receiving the IR command library from the flash memory and directing the IR command library to an IR encoder;
an IR emitter connected to the IR encoder for transmitting the IR command library, wherein receipt of the IR command associated with the RCID by that RCID interferes with the recording of a visual image by that RCID.

2. The portable camera controller of claim 1, wherein the at least one IR command associated with the RCID is selected from the group consisting of a stop command, a pause command, and a rewind command.

3. The portable camera controller of claim 1, wherein the RCID is a remotely controllable video camera selected from the group consisting of a video camera using tape storage, a video camera using disk storage, a video camera using electronic storage, and a video camera using optical storage.

4. The portable camera controller of claim 1 further comprising a timer connected to the processor and wherein the processor is adapted to respond to a timing pulse from the timer by retrieving and transmitting the IR command library.

5. The portable camera controller of claim 4, wherein the timer is adapted to send the timing pulse periodically to the processor.

6. A portable camera controller comprising:
a flash memory comprising an infrared (IR) command library, wherein the IR command library comprises at least one IR command associated with a remotely controllable imaging devices (RCIDs);
a processor for receiving the IR command library from the flash memory and directing the IR command library to an IR encoder; and
an IR emitter connected to the IR encoder for transmitting the IR command library, wherein receipt of the at least one IR command associated with the RCID by the RCID interferes with the recording of a visual image by the RCID.

7. The portable camera controller of claim 6, wherein the IR command associated with the RCID is selected from the group consisting of a stop command, a pause command, and a rewind command.

8. The portable camera controller of claim 6, wherein the RCID is a remotely controllable video camera selected from the group consisting of a video camera using tape storage, a video camera using disk storage, a video camera using electronic storage, and a video camera using optical storage.

9. The portable camera controller of claim 6, wherein the IR emitter is arranged so as to transmit the IR command library omnidirectionally.

10. A method for thwarting the recording of a visual image using a portable camera controller, the method comprising:
generating a timing pulse;
in response to the timing pulse, retrieving an IR command library, wherein the IR command library comprises an IR command associated with a remotely controllable imaging device (RCID);
transmitting the IR command library from an IR emitter, wherein receipt of the IR command associated with the RCID by the RCID interferes with the recording of a visual image by the RCID.

11. The method for thwarting the recording of a visual image using a portable camera controller of claim 10, wherein the IR command associated with the RCID is selected from the group consisting of a stop command, a pause command, and a rewind command.

12. The method for thwarting the recording of a visual image using a portable camera controller of claim 10, wherein the RCID is a remotely controllable video camera selected from the group consisting of a video camera using tape storage, a video camera using disk storage, a video camera using electronic storage, and a video camera using optical storage.

13. The method for thwarting the recording of a visual image using a portable camera controller of claim 10, wherein generating a timing pulse comprises generating a timing pulse periodically.
